(19) United States
(12) Patent Application Publication
(10) Pub. No.: US 2011/0058057 A1
(43) Pub. Date: Mar. 10, 2011

(54) IMAGE CAPTURE DEVICE AND METHOD, IMAGE PROCESSING DEVICE AND METHOD, AND PROGRAM

(75) Inventors: Nodoka TOKUNAGA, Tokyo (JP); Jun Murayama, Tokyo (JP)

(73) Assignee: Sony Corporation, Tokyo (JP)

(21) Appl. No.: 12/845,239

(22) Filed: Jul. 28, 2010

(30) Foreign Application Priority Data
Sep. 4, 2009 (JP) 2009-204424

(51) Int. Cl. H04N 5/228

(52) U.S. Cl. 348/222.1; 348/E05.031

(57) ABSTRACT

An image capture device includes: a request-data obtaining unit configured to obtain request data output from an image processing device; a determining unit configured to determine whether or not an input image is an image requested by the image processing device, on a basis of information contained in the request data; a presenting unit configured to present a user with a result of the determination; and a saving configured to save the input image at timing designated by the user.

### BACKGROUND OF THE INVENTION

1. Field of the Invention

The present invention relates to an image capture device and method, an image processing device and method, and a program. More particularly, the present invention relates to an image capture device and method, an image processing device and method, and a program which make it possibility to easily collect images to be used for creating a beautiful photomosaic.

2. Description of the Related Art

With widespread use of digital cameras and so on in recent years, it has become possible to easily photograph a large number of images.

A photomosaic (photographic mosaic) is an image created by combining a large number of pictures into a mosaic-like pattern. In the past, photomosaics were in many cases created for commercial purposes, such as posters for movie promotion, ones using cooperate logos, and so on. Creation of a photomosaic involves preparation of a large number of images and an advanced technology for, for example, appropriately selecting images to be used as mosaic tiles.

In conjunction with the widespread use of digital cameras and advancement of information technologies, it has become possible for even general users to create photomosaic images.

Photo-mosaicing is to create a single large image by combining a large number of small images, such as small pictures, as mosaic tiles. A photomosaic image is created such that, for example, when viewed at a distance, it appears as a single picture, and when observed at a short distance, it reveals individual images that constitute mosaic tiles.

For example, when a photomosaic image in which a large number of the same images are used as mosaic tiles is viewed at a distance, it appears to be an image having an unnatural pattern. It can be said that a photomosaic image that gives such an unnatural impression is low in quality, for example, particularly, when an image of a human face is created by photo-mosaicing.

Thus, creation of a high-quality photomosaic image typically uses a large number of images, such as pictures, that can be used as mosaic tiles and also creates an image database or the like that stores such a large number of images.

For example, Japanese Unexamined Patent Application Publication No. 11-345311 discloses a technology in which multiple tile images are derived by clipping partial images from a prepared tile image to make it possible to increase the number of images used as mosaic tiles, thereby enhancing the quality of a photomosaic image.

### SUMMARY OF THE INVENTION

However, in the technology disclosed in Japanese Unexamined Patent Application Publication No. 11-345311, since only the number of images derived from an already-existing image increases, an increase in the number of images that are suitable for use in an images to be created (which may be referred to as a “target image” hereinafter) is not ensured. That is, in order to enable a photomosaic image to express texture of a target image, it is generally necessary to prepare images that are suitable to be attached to blocks of the target image.

In general, for example, a picture obtained by photographing an object whose entire surface is red, blue, or the like is not suitable as an image to be used as a mosaic tile. This is because the photomosaic image has an aesthetic feature in that, for example, the observer's impression varies greatly between when viewed at a distance and when observed at a short distance.

It has, however, been difficult for a general user to intentionally photograph images that are suitable as such mosaic tiles, thus making it difficult to create an image database or the like.

Accordingly, it is desirable to make it possible to easily collect images to be used for creating a beautiful photomosaic.

According to a first embodiment of the present invention, there is provided an image capture device. The image capture device includes: request-data obtaining means for obtaining request data output from an image processing device; determining means for determining whether or not an input image is an image requested by the image processing device, on the basis of information contained in the request data; presenting means for presenting a user with a result of the determination; and saving means for saving the input image at timing designated by the user.

The request data may contain information of preset classes and a center value of each class; and the determining means may classify the input image into one of the classes by determining a distance between a representative value of the input image and the center value. When the request data contains information indicating that the number of images in the class of the input image is insufficient, the determining means may determine that the input image is the image requested by the image processing device.

The request data may further contain a threshold for classifying the input image into one of the classes. When the distance between the representative value of the input image and the center value is smaller than or equal to the threshold, the determining means may classify the input image into the class corresponding to the center value.

The determining means may further determine a similarity between an image already saved by the saving means and the input image. When the request data contains the information indicating that the number of images in the class of the input image is insufficient and the similarity is smaller than or equal to a threshold, the determining means may determine that the input image is the image requested by the image processing device.

The image capture device may further include automatic saving means for saving, regardless of designation by the user, the input image determined by the determining means to be the image requested by the image processing device.

The image capture device may further include sending means for sending the saved input image to the image processing device as a material image to be used for creating a photomosaic image.

According to the first embodiment of the present invention, there is further provided an image capture method. The image capture method include the steps of: causing request-data obtaining means to obtain request data output from an image processing device; causing determining means to determine whether or not an input image is an image requested by the image processing device, on the basis of information contained in the request data; causing presenting means to present a user with a result of the determination; and causing saving means to save the input image at timing designated by the user.

According to the first embodiment of the present invention, there is further provided a program that causes a computer to function as an image capture device. The image capture device includes: request-data obtaining means for obtaining request data output from an image processing device; determining means for determining whether or not an input image is an image requested by the image processing device, on the basis of information contained in the request data; presenting means for presenting a user with a result of the determination; and saving means for saving the input image at timing designated by the user.

According to the first embodiment of the present invention, request data output from an image processing device is obtained; whether or not an input image is an image requested by the image processing device is determined on the basis of information contained in the request data; a user is presented with a result of the determination; and the input image is saved at timing designated by the user.

According to a second embodiment of the present invention, there is provided an image processing device. The image processing device includes: dividing means for dividing an input image into blocks; block-image classifying means for classifying the divided blocks into preset classes, on the basis of representative values of the images of the blocks; material-image classifying means for classifying material images, stored as images to be attached to the blocks, into the classes; comparing means for comparing the number of blocks classified into each of the classes with the number of material images classified into each of the classes; insufficient-image identifying means for identifying a class in which the number of material images is insufficient and the number of insufficient material images, on the basis of a result of the comparison; request-data generating means for generating request data containing the identified class, the number of insufficient material images, and a center value of the class; and sending means for sending the generated request data to an image capture device.

The image processing device may further include material-image determining means for determining the material image to be attached to each block, by comparing each of the material images, classified into the same class as the class of the block, with the image of the block in accordance with a predetermined criteria; and photomosaic-image creating means for creating a photomosaic image corresponding to the input image by attaching the determined material image to the block.

The material-image determining means may perform the comparison by determining suitability of the material image to be attached to the block on the basis of a distance between a pixel value of the material image, classified into the same class as the class of the block, with a pixel value of a corresponding pixel in the image of the block.

The block-image classifying means may include center-value determining means for determining the center values of the classes on the basis of the representative values of the images of the blocks, and classifies the images of the blocks into the classes on the basis of a distance between the center value and the representative value of the image of the block. The material-image classifying means may classify the material images into the classes on the basis of the distance between the center value and the representative value of the material image and a threshold for the distance.

According to the second embodiment of the present invention, there is further provided an image processing method. The image processing method includes the steps of: causing dividing means to divide an input image into blocks; causing block-image classifying means to classify the divided blocks into preset classes, on the basis of representative values of the images of the blocks; causing material-image classifying means to classify material images, stored as images to be attached to the blocks, into the classes; causing comparing means to compare the number of blocks classified into each of the classes with the number of material images classified into each of the classes; causing insufficient-image identifying means to identify a class in which the number of material images is insufficient and the number of insufficient material images, on the basis of a result of the comparison; causing request-data generating means to generate request data containing the identified class, the number of insufficient material images, and a center value of the class; and causing sending means to send the generated request data to an image capture device.

According to the second embodiment of the present invention, there is further provided a program causing a computer to function as an image processing device. The image processing device includes: dividing means for dividing an input image into blocks; block-image classifying means for classifying the divided blocks into preset classes, on the basis of representative values of the images of the blocks; material-image classifying means for classifying material images, stored as images to be attached to the blocks, into the classes; comparing means for comparing the number of blocks classified into each of the classes with the number of material images classified into each of the classes; insufficient-image identifying means for identifying a class in which the number of material images is insufficient and the number of insufficient material images, on the basis of a result of the comparison; request-data generating means for generating request data containing the identified class, the number of insufficient material images, and a center value of the class; and sending means for sending the generated request data to an image capture device.

According to the second embodiment of the present invention, an input image is divided into blocks; the divided blocks are classified into preset classes, on the basis of representative values of the images of the blocks; material images stored as images to be attached to the blocks are classified into the classes; the number of blocks classified into each of the classes are compared with the number of material images classified into each of the classes; a class in which the number of material images is insufficient and the number of insufficient material images are identified on the basis of a result of the comparison; request data containing the identified class, the number of insufficient material images, and a center value of the class is generated; and the generated request data is sent to an image capture device.

According to the present invention, it is possible to easily collect images to be used for creating a beautiful photomosaic.

### BRIEF DESCRIPTION OF THE DRAWINGS

FIG. 1 is a block diagram showing an example of the configuration of a photomosaic-image creating system according to one embodiment of the present invention;

FIG. 2 is a block diagram showing an example of a detailed configuration of the photomosaic-image creator shown in FIG. 1;

FIG. 3 is a diagram illustrating a restriction of N neighborhood;

FIG. 4 is a block diagram showing an example of a detailed configuration of the image request processor shown in FIG. 1;

FIG. 5 is a flowchart illustrating an example of image creation processing;

FIG. 6 shows an example of a target image;

FIG. 7 shows an example of an image obtained by painting blocks of the target image with pixels having representative values of the blocks;

FIG. 8 is a flowchart illustrating an example of classification processing;

FIG. 9 shows an example of an image resulting from classification of the blocks shown in FIG. 7;

FIG. 10 is a flowchart illustrating an example of replacement-image determination processing;

FIG. 11 shows an example of a photomosaic image;

FIG. 12 is a flowchart illustrating an example of material-image request processing;

FIG. 13 is a flowchart illustrating an example of request generation processing;

FIG. 14 is a block diagram showing an example of a detailed configuration of the image capture device shown in FIG. 1;

FIG. 15 is a flowchart illustrating an example of image obtaining processing;

FIG. 16 is a block diagram showing another example of the detailed configuration of the image capture device shown in FIG. 1;

FIG. 17 is a flowchart illustrating another example of the image obtaining processing; and

FIG. 18 is a block diagram illustrating an example of the configuration of a personal computer.

### DESCRIPTION OF THE PREFERRED EMBODIMENTS

Embodiments of the present invention will be described below with reference to the accompanying drawings.

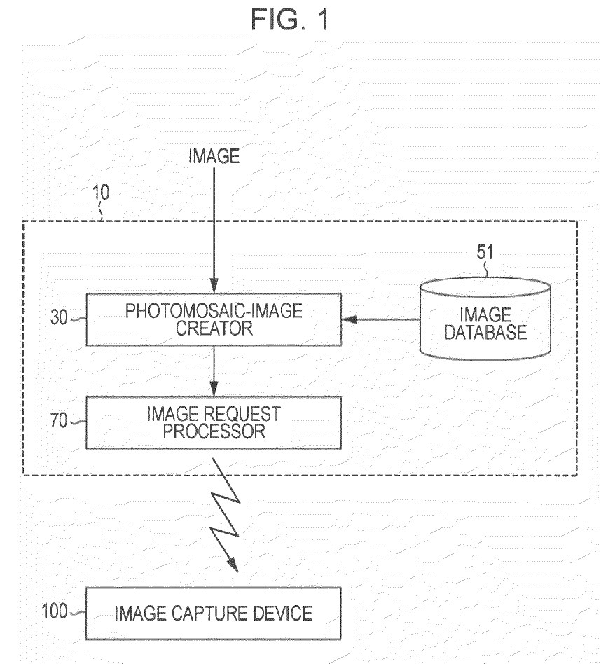

FIG. 1 is a block diagram showing an example of the configuration of a photomosaic-image creating system according to one embodiment of the present invention.

Photo-mosaicing is to create a single large image by combining a large number of small images, such as small pictures, into a mosaic-like pattern. A photomosaic image is created such that, for example, when viewed at a distance, it appears as a single picture, and when observed at a short distance, it reveals individual images that constitute mosaic tiles.

As shown in FIG. 1, a photomosaic-image creating system includes a photomosaic-image creating device 10 and an image capture device 100.

Upon input of an image to be created (i.e., a target image), a photomosaic-image creator 30 in the photomosaic-image creating device 10 divides the target image into blocks. The blocks have, for example, equal-sized rectangular shapes, and each block is adapted such that one image for a mosaic tile is attached thereto.

The photomosaic-image creator 30 is adapted to select images suitable for the blocks and attach the selected images thereto.

The photomosaic-image creator 30 selects the images suitable for the blocks of the target image, for example, from images stored in an image database 51. Alternatively, the photomosaic-image creator 30 may select the images suitable for the blocks of the target image, for example, from images stored on a server connected through a network or the like.

That is, the images, such as the images stored in the image database 51, are images used as mosaic tiles and provide materials for a photomosaic image.

The photomosaic-image creator 30 is adapted to perform classification on the basis of, for example, pixel values of the blocks of the target image. Thus, the blocks of the target image are classified into, for example, five classes. By using a similar scheme, the photomosaic-image creator 30 also classifies the images, stored in the image database 51, into, for example, five classes.

The photomosaic-image creator 30 is adapted to compare the image of each block of the target image with the images stored in the image database 51 and classified into the class of the block and to select one image from the images stored in the image database 51.

The photomosaic-image creator 30 attaches, as a mosaic tile, the image selected as described above to the corresponding block of the target image. Consequently, a photomosaic image is output as an output image.

An image request processor 70 in the photomosaic-image creating device 10 generates information for requesting the image capture device 100 to obtain an image images, on the basis of the result of the classification of the blocks of the target image, the classification being performed by the photomosaic-image creator 30, and the result of the classification of the images stored in the image database 51.

The image request processor 70 compares the number of blocks of the target image, the blocks being classified into each of the classes, with the number of images stored in the image database 51 and classified into each of the classes. The image request processor 70 then identifies a class not having sufficient images in the image database 51. The image request processor 70 further generates, as request data, information to be used for obtaining an image or images in the class not having sufficient images and transmits the request data to the image capture device 100 through, for example, wireless communication.

The communication of the image request processor 70 with the image capture device 100 may be performed via wired communication, a memory card, or the like.

The image capture device 100 may be implemented as, for example, a digital camera. On the basis of the request data transmitted from the photomosaic-image creating device 10, the image capture device 100 is adapted to capture an image or images, save the image(s), and transmit the saved-image(s) to the photomosaic-image creating device 10 through, for example, wireless communication.

The image capture device 100 is adapted to capture, for example, an image in the class not having sufficient images. That is, the image capture device 100 is configured so that, through pre-classification or the like, it can determine whether or not an image obtained from light focused by a lens or the like is an image in the class not having sufficient images. The image capture device 100 captures an image determined to be an image in the class not having sufficient images and transmits the captured image to the photomosaic-image creating device 10. The transmitted image may be stored in the image database 51 in the photomosaic-image creating device 10.

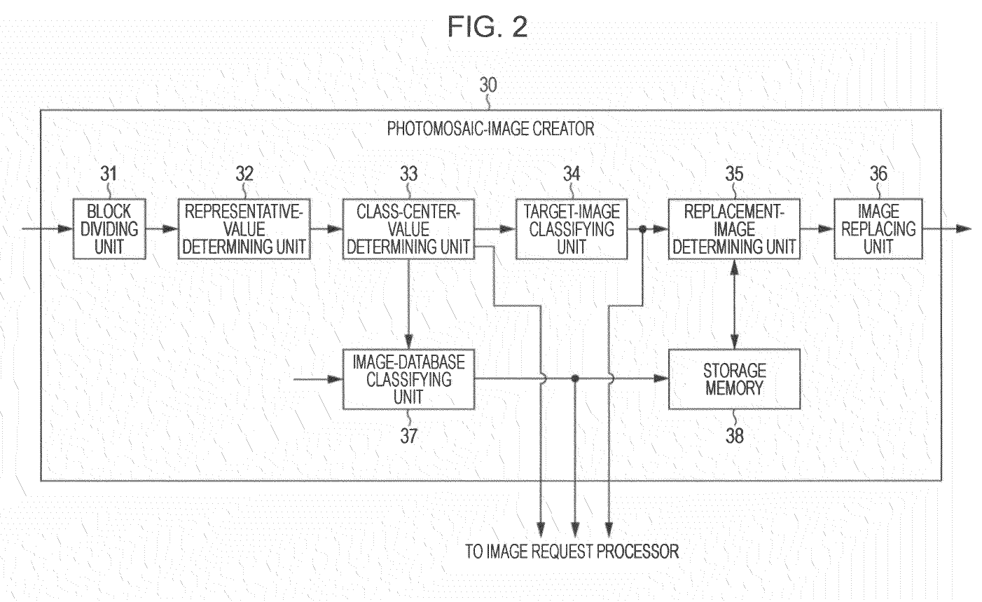

FIG. 2 is a block diagram showing an example of a detailed configuration of the photomosaic-image creator 30 shown in FIG. 1.

As shown in FIG. 2, the photomosaic-image creator 30 includes a block dividing unit 31, a representative-value determining unit 32, a class-center-value determining unit 33, and a target-image classifying unit 34. The photomosaic-image creator 30 further includes a replacement-image determining unit 35, an image replacing unit 36, an image-database classifying unit 37, and a storage memory 38.

The block dividing unit 31 divides a target image into blocks. The blocks have, for example, equal-sized rectangular shapes, and each block is adapted such that one image for a mosaic tile is attached thereto.

The block dividing unit 31 may divides a target image into, for example, rectangular blocks constituted by 320 pixels in a horizontal direction and 240 pixels in a vertical direction.

The representative-value determining unit 32 determines a representative value of each of the blocks divided by the block dividing unit 31. Each representative value may be, for example, an average value of pixel values of the block or a pixel value at the center coordinate position of the block. Alternatively, each representative value may be an average value of pixel values at predetermined coordinate positions in the block.

For example, by a clustering scheme such as a K-means method, the class-center-value determining unit 33 determines a center value of each class, the center value being used for classification. The target-image classifying unit 34 and the image-database classifying unit 37, which are described below, are adapted to perform classifications based on the center values determined by the class-center-value determining unit 33.

When the target-image classifying unit 34 and the image-database classifying unit 37 classify the images into five classes, the class-center-value determining unit 33 temporarily set, as respective center values of the five classes, the representative values of the five blocks at edges of the target image. Thereafter, the class-center-value determining unit 33 compares the center value of each class with the representative values to classify the blocks into five classes.

The class-center-value determining unit 33 calculates a square sum of absolute differences in R (red), G (green), and B (blue) components between a pixel value corresponding to the center value temporarily set as described above and a pixel value corresponding to the representative value of each block, to thereby determine a distance between the center value of each class and the representative value of the block. The class-center-value determining unit 33 then classifies the block into a class to which the distance is the closest.

After a predetermined number of blocks are classified as described above, the class-center-value determining unit 33 temporarily sets a center value of each class again by determining, for example, an average value of the representative values of all blocks in each class. The class-center-value determining unit 33 determines a distance between the center value of each class and the representative value of each block, as in the manner described above, to perform block classification again.

The class-center-value determining unit 33 executes processing for such block classification, for example, until it is executed a predetermined number of times. The class-center-value determining unit 33 is adapted to supply, as a final center value of each class, the value, obtained by, for example, determination of the average value of the representative values of all blocks in each class, to the target-image classifying unit 34 and the image-database classifying unit 37.

The class-center-value determining unit 33 is adapted to also supply the each-class center value, determined thereby, to the image request processor 70.

The center value is determined as, for example, values of RGB components for each class. For example, for classification into class 1, class 2, class 3, . . . , the center value of class 1 is determined to be (235.9444, 147.9211, 71.6848), the center value of class 2 is determined to be (177.6508, 115.0474, 61.7452), and the center value of class 3 is determined to be (76.7123, 63.5517, 42.3792). The three elements of the center value represent the values of an R component, a G component, and a B component.

The above-described center-value determination scheme is merely one example and another scheme may be used to determine the center value of each class.

The target-image classifying unit 34 classifies the images of the blocks, divided by the block dividing unit 31, into classes, on the basis of the class center values supplied from the class-center-value determining unit 33. The target-image classifying unit 34 performs the classification by determining, for example, a distance between the center value of each class and the representative value of each block, as in the case described above.

The result of the block-image classification performed by the target-image classifying unit 34 may be supplied to the replacement-image determining unit 35 and the image request processor 70.

The image-database classifying unit 37 is adapted to classify the images stored in, for example, the image database 51, on the basis of the class center values supplied from the class-center-value determining unit 33.

The image-database classifying unit 37 performs the classification by determining, for example, a distance between the center value of each class and the representative value of each image in the image database 51, as in the case described above. However, the image-database classifying unit 37 is adapted so as not to classify an image, stored in the image database 51, into any class when the distance between the center value of a closest class and the representative value of the image exceeds a threshold.

The threshold used for the classification performed by the image-database classifying unit 37 may be varied according to, for example, the number of classified images. Thus, for example, when the number of images classified into a certain class is extremely small, increasing the threshold makes it possible increase the number of images classified into the certain class.

Thus, for example, the image-database classifying unit 37 may check, for each class, the number of images classified once, and when it is determined that the number of images classified into a certain class does not reach a reference value, the threshold may be varied for re-classification.

The identical image may also be classified into multiple classes as a result of the varied threshold.

The images classified by the image-database classifying unit 37 may be stored in the storage memory 38 in association with the corresponding classes into which the images are classified.

The result of the classification of the images in the image database 51, the classification being performed by the image-database classifying unit 37, may also be supplied to the image request processor 70.

The arrangement may also be such that the images stored in the image database 51 are subjected to filter processing for eliminating motion blur and bokeh and the resulting images are stored in the storage memory 38 in association with the corresponding classes into which the images are classified.

With this arrangement, it is possible to make a finished photomosaic image more beautiful.

The replacement-image determining unit 35 is adapted to execute processing for comparing the image of each block classified by the target-image classifying unit 34 with a group of images stored in the storage memory 38 and included in the class of the block, by performing calculation using an expression noted below.

In the image comparison processing, for example, Δc is first determined by computation given by:

$$Δ c = \sqrt{( 2 + \frac{\overline{r}}{256} ) * Δ {R}^{2} + {4}^{*} Δ {G}^{2} + {( 2 + \frac{255 - \overline{r}}{256} )}^{*} Δ {B}^{2}} \\ \overline{r} = \frac{{C}_{1 R} + {C}_{2 R}}{2} \qquad ( 1 )$$

In this case, ΔR, ΔG, and ΔB indicate differences in the values of R, G, and B components of the pixel values between a predetermined one pixel in the image of each block and a corresponding pixel in the image stored in the storage memory 38. C_{1R} indicates the value of an R component of a predetermined pixel in the image of each block and C_{2R} indicates the value of an R component of the pixel values of a corresponding pixel in the image stored in the storage memory 38.

The determination of Δc by using expression (1) is performed on all pixels included in the image of each block. For example, Δc is determined with respect to each pixel represented by a coordinate position xy in the block.

In the image comparison processing, computation given by expression (2) is performed to determine C. That is, the differences Δc, determined by expression (1), with respect to all pixels in the block are summed.

$$C = {\sum }_{x} {\sum }_{y} Δ {C}_{xy} \qquad ( 2 )$$

The value of C determined by expression (2) is stored in association with the corresponding image stored in the storage memory 38. The replacement-image determining unit 35 compares the values of C with respect to the images stored in the storage memory 38. That is, the value of C represents how much the image is suitable (i.e., suitability) as an image to be attached to the corresponding block. The smaller the value of C is, the more suitable the image is.

The computations given by expressions (1) and (2) may be performed after the pixels in the blocks of the target image and the pixels in the images in the image database 51 are thinned out. This arrangement can achieve, for example, a reduction in the amount of computation and a reduction in the processing time.

The above-described image comparison processing is merely one example and another scheme may also be employed to perform the image comparison. That is, the image comparison processing may be realized by any scheme that can determine, out of the images stored in the image database 51 and classified based on the representative values, an image that is suitable for expressing texture of each block of the target image as an image to be attached to (or to replace the image of) the corresponding block.

The replacement-image determining unit 35 is adapted to determine, as an image to be attached to (or to replace the image of) the block, an image whose value of C is the smallest. The replacement-image determining unit 35 supplies the thus-determined image to the image replacing unit 36.

The image replacing unit 36 replaces the image of the block with the image supplied from the replacement-image determining unit 35. Through such processing, the images of all blocks are replaced with the images supplied from the replacement-image determining unit 35, so that a mosaic image is created.

The replacement-image determining unit 35 sets, for example, predetermined flags for the images, stored in the storage memory 38, to thereby determine replacement images so that the same image is not used for multiple blocks. The replacement-image determining unit 35 is adapted to determine, as a replacement image, an image for which no flag is set, until the flags are set for, of the images stored in the storage memory 38, all images classified into the same class. When the flags are set for all images classified into the same class, all of the flags for the images in the class may be cleared.

Alternatively, a restriction may be placed such that the replacement-image determining unit 35 does not use only images in N neighborhood, rather than not using any images for which the flags are set. The expression “N neighborhood” as used herein refers to N blocks adjacent to one block. The value of N may be, for example, 8, 24, or the like.

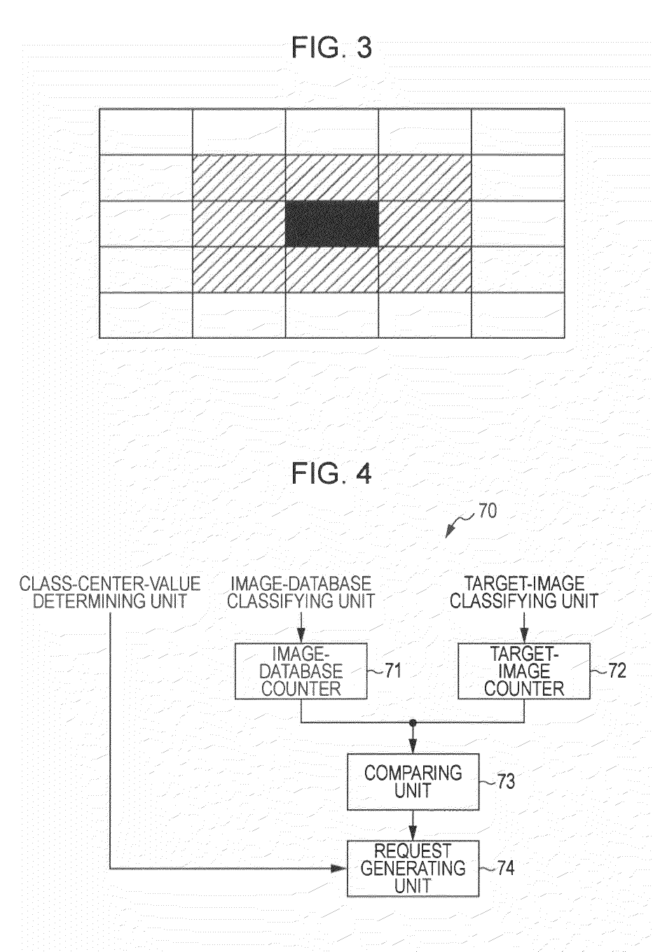

For example, when the value of N is 8, the restriction of N neighborhood is expressed as shown in FIG. 3. In FIG. 3, each rectangle represents one of blocks of a target image. For example, as shown in FIG. 3, an image used in the block represented by the black rectangle at the center of the figure is adapted so as not to be used for eight hatched blocks in the figure. That is, in the presence of the restriction of N neighborhood, the replacement-image determining unit 35 determines, out of images other than the image used in the block represented by the black rectangle, images to be attached to the eight hatched blocks in the figure.

With this arrangement, for example, it is possible to create a beautiful mosaic even when the number of images that are usable as mosaic tiles is limited.

In the past, for example, since only the representative values have been used to determine images that are stored in the image database 51 and that are to be attached to the blocks, it has in many cases been difficult to enable a created photomosaic image to express texture of a target image. When the image of each block is compared with the images in the image database 51 in order to make it possible to express the texture of the target image, it has generally been necessary to compare each block of the target image with all images in the image database 51. This involves a large amount of computation and a large amount of processing time.

In contrast, according to the present invention, the blocks of a target image and the images in the image database 51 are classified using the same center values and only the images in the same class are used for the comparison. With this arrangement, according to the present invention, texture of the target image can be expressed by a created photomosaic image and a reduction in the amount of computation and a reduction in the processing time can be achieved.

FIG. 4 is a block diagram showing an example of a detailed configuration of the image request processor 70 shown in FIG. 1.

As shown in FIG. 4, the image request processor 70 includes an image-database counter 71, a target-image counter 72, a comparing unit 73, and a request generating unit 74.

The image-database counter 71 is adapted to count the number of images classified into each class, on the basis of the result of the classification of the images stored in the image database 51, the classification being performed by the image-database classifying unit 37.

The target-image counter 72 is adapted to count the number of blocks classified into each class, on the basis of the result of the classification of the images of the blocks, the classification being performed by the target-image classifying unit 34.

The comparing unit 73 compares the number of blocks counted by the target-image counter 72 with the number of images counted by the image-database counter 71. That is, the comparing unit 73 compares the number of blocks of the target image, the blocks being classified into each class, with the number of images stored in the image database 51 and classified in the corresponding class. The comparing unit 73 then identifies a class not having sufficient images in the image database 51.

The comparing unit 73 supplies, to the request generating unit 74, for example, information indicating in which class and how many images in the image database 51 are insufficient as a result of the above-described comparison.

The request generating unit 74 is adapted to generate request data on the basis of the information supplied from the comparing unit 73 and the each-class center value determined by the class-center-value determining unit 33. That is, the request generating unit 74 generates request data containing information indicating in which class and how many images in the image database 51 are insufficient and the center value of the class not having sufficient images. The request data may also contain the threshold used for the classification performed by the image-database classifying unit 37.

As described above, the request data generated by the request generating unit 74 is transmitted, as information to be used for obtaining an image or images in the class not having sufficient images, to the image capture device 100 through, for example, wireless communication.

Thus, the image request processor 70 can transmit, to the image capture device 100, the information to be used for obtaining the image(s) in the class not having sufficient images in the image database 51, the images being used for creating the photomosaic image. Thus, through image capture, the image capture device 100 can obtain the image(s) in the class not having sufficient images in the image database 51, the images being used for creating the photomosaic image.

Typically, for example, there is a problem in that, when sufficient images are not prepared in the image database, the same image is used for many blocks and the quality of a created photomosaic image is reduced.

For example, when a photomosaic image in which a large number of the same images are used as mosaic tiles is viewed at a distance, it appears to be an image having an unnatural pattern. It can be said that a photomosaic image that gives such an unnatural impression is low in quality, for example, particularly, when an image of a human face is created by photo-mosaicing.

According to the present invention, for example, when the number of images classified into a certain class is small, a request for obtaining images in the class can be given to the image capture device 100.

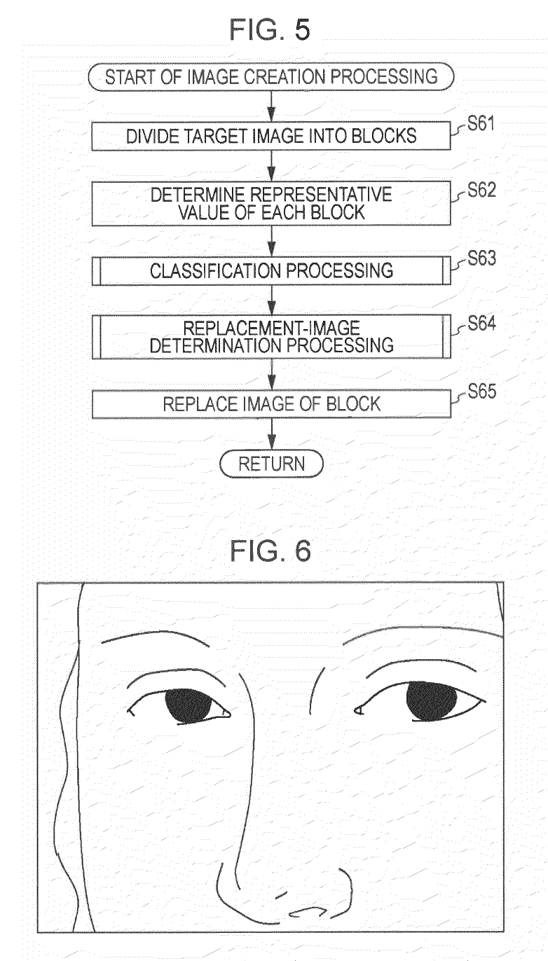

A detailed example of image creation processing performed by the photomosaic-image creator 30 shown in FIG. 1 will now be described with reference to a flowchart shown in FIG. 5.

In step S61, the block dividing unit 31 in the photomosaic-image creator 30 divides a target image into blocks. In this case, the block dividing unit 31 divides a target image into, for example, rectangular blocks constituted by 320 pixels in a horizontal direction and 240 pixels in a vertical direction.

In step S62, the representative-value determining unit 32 determines a representative value of each of the blocks divided in the processing in step S61. Each representative value may be, for example, an average value of pixel values of the block or a pixel value at the center coordinate position of the block. Alternatively, each representative value may be an average value of pixel values at predetermined coordinate positions in the block.

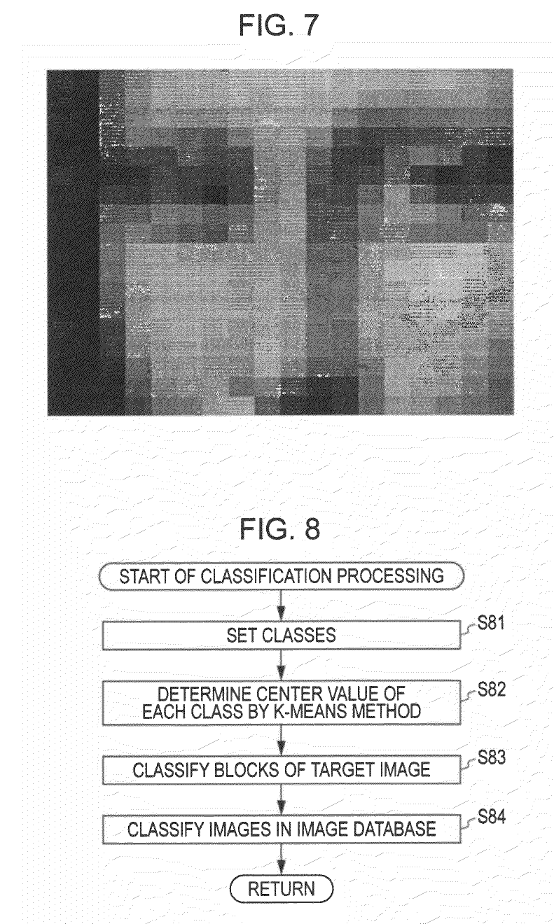

FIGS. 6 and 7 are images illustrating block division and representative-value determination.

For example, when an image as illustrated in FIG. 6 is input as a target image, in the processing in step S61, the illustrated image is divided into rectangular blocks constituted by 320 pixels in the horizontal direction and 240 pixels in the vertical direction. In this example, an image of a human face, as illustrated in FIG. 6, is input as a target image.

As described above, in the processing in step S62, a representative value of each block is determined. FIG. 7 shows an example of an image obtained by painting the blocks of the target image with pixels having the respective representative values of the blocks, for ease of understanding of the blocks. As shown in FIG. 7, a human-face image shown in FIG. 7 is divided into rectangular blocks.

Referring back to FIG. 5, in step S63, the target-image classifying unit 34 and the image-database classifying unit 37 execute classification processing. In this case, the class-center-value determining unit 33, the target-image classifying unit 34, and the image-database classifying unit 37 classify the image of each of the blocks and each of the images stored in the image database 51, on the basis of the block representative values determined in the processing in step S62.

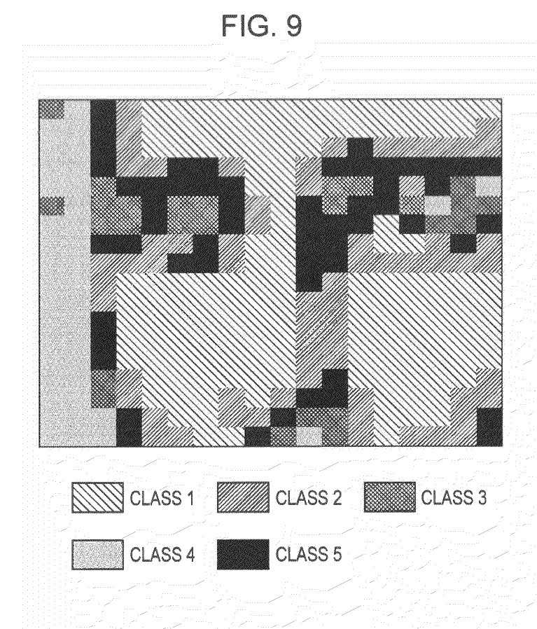

A detailed example of the classification processing in step S63 in FIG. 5 will now be described with reference to a flowchart shown in FIG. 8.

In step S81, the class-center-value determining unit 33 sets classes. In this case, for example, five classes are set.

In step S82, for example, using a clustering scheme such as a K-means method, the class-center-value determining unit 33 determines a center value of each class, the center value being used for the classification.

In this case, the class-center-value determining unit 33 temporarily sets, as center values of the five classes set in the processing in step S81, the representative values of five blocks at edges of the target image. Thereafter, the class-center-value determining unit 33 compares the center value of each class with the representative values to classify the blocks into the five classes.

The class-center-value determining unit 33 calculates a square sum of absolute differences in RGB components between a pixel value corresponding to the center value temporarily set as described above and a pixel value corresponding to the representative value of each block, to thereby determine a distance between the center value of each class and the representative value of the block. The class-center-value determining unit 33 then classifies the block into a class to which the distance is the closest.

After a predetermined number of blocks are classified as a result of such processing, the class-center-value determining unit 33 temporarily sets the center value of each class again by determining, for example, an average value of the representative values of all blocks in each class. The class-center-value determining unit 33 determines a distance between the center value of each class and the representative value of each block, as in the case described above, to perform block classification again.

The class-center-value determining unit 33 executes processing for such block classification, for example, until it is executed a predetermined number of times. The class-center-value determining unit 33 then determines, as the final center value of each class, the value obtained by, for example, determination of the average value of the representative values of all blocks in each class.

In processing in step S82, for example, the center value of each class is determined as described above.

In step S83, the target-image classifying unit 34 classifies the images of the blocks divided in the processing in step S61, on the basis of the each-class center value determined in the processing in step S82. The target-image classifying unit 34 performs the classification by determining, for example, a distance between the center value of each class and the representative value of each block, as in the case described above.

As a result, for example, the blocks of the image divided into the blocks, as shown in FIG. 7, are classified as shown in FIG. 9. FIG. 9 shows an image, which represents an example in which the blocks shown in FIG. 7 are classified through the processing in step S83.

In FIG. 9, the class of each block is represented by a hatched pattern. In the example shown in FIG. 9, the blocks of the target image are classified into five classes, namely, class 1 to class 5.

In step S84, the image-database classifying unit 37 classifies, for example, the images in the image database 51, on the basis of the each-class center value determined in the processing in step S82.

The image-database classifying unit 37 performs the classification by determining, for example, a distance between the center value of each class and the representative value of each image in the image database 51, as in the case described above. However, in the processing in step S84, when the distance between the center value of a closest class and the representative value of each image in the image database 51 exceeds a threshold, the image-database classifying unit 37 is adapted so as not to classify the image into any class.

As described above, the threshold used for the classification performed by the image-database classifying unit 37 may be varied according to, for example, the number of classified images. With such an arrangement, for example, when the number of images classified into a certain class is extremely small, increasing the threshold makes it possible to increase the number of images classified into the certain class.

The images classified in the processing in step S84 may be stored in the storage memory 38 in association with the corresponding classes into which the images are classified.

The classification processing is executed as described above.

Referring back to FIG. 5, in step S64 subsequent to the processing in step S63, the replacement-image determining unit 35 executes replacement-image determination processing. In this processing, the images of the blocks of the target image are replaced with the images in the image database 51, so that a photomosaic image is created.

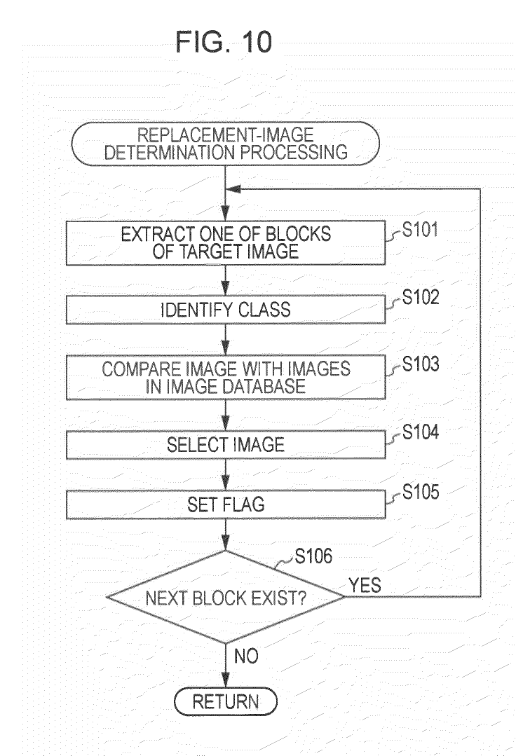

A detailed example of the replacement-image determination processing in step S64 in FIG. 5 will now be described with reference to a flowchart shown in FIG. 10.

In step S101, the replacement-image determining unit 35 extracts one of the blocks of the target image.

In step S102, with respect to the block extracted in step S101, the replacement-image determining unit 35 identifies a class into which the image was classified in the processing in step S63.

In step S103, the replacement-image determining unit 35 compares the image of the block with a group of images read from the image database 51, stored in the storage memory 38, and included in the class identified in the processing in step S102.

In this case, for example, processing for the image comparison is executed based on calculation as described below.

For example, as described above, the computation given by expression (1) is performed to determine Δc and the computation given by expression (2) is performed to determine C. That is, the differences Δc, determined by expression (1), with respect to all pixels in the block are summed.

The computations given by expressions (1) and (2) may be performed after the pixels in the blocks of the target image and the pixels in the images in the image database 51 are thinned out. This arrangement can achieve, for example, a reduction in the amount of computation and a reduction in the processing time.

The comparison in step S103 is performed on each of the images in the class identified in the processing in step S102 and the values of C determined by expression (2) are stored in association with the images stored in the storage memory 38.

In step S104, the replacement-image determining unit 35 selects an image to be attached to the block, on the basis of the result of the processing in step S103.

In this case, for example, the replacement-image determining unit 35 compares the values of C with respect to the images stored in the storage memory 38. The replacement-image determining unit 35 then determines, as an image to be attached to (or to replace the image of) the block, an image whose value of C is the smallest.

In step S105, the replacement-image determining unit 35 sets a flag for the image selected in the processing in step S104. Consequently, when the processing in step S103 is performed subsequently, the image for which the flag is set is excluded from the comparison.

The replacement-image determining unit 35 is adapted to determine, as a replacement image, an image for which no flag is set, until the flags are set for, of the images stored in the storage memory 38, all images classified into the same class. When the flags are set for all images classified into the same class, all of the flags for the images in the class may be cleared.

In step S106, the replacement-image determining unit 35 determines whether or not a next block exists. That is, the replacement-image determining unit 35 determines whether or not the target image has any block for which the replacement image has not been determined (selected) yet.

When it is determined in step S106 that a next block exists, the process returns to step S101 and the processing in step S101 and the subsequent steps is executed again.

When it is determined in step S106 that a next block does not exist, the replacement-image determination processing is finished.

Although the description has been given of an example in which the flags are set in the determination of the replacement images so as to prevent the same image from being used for multiple blocks, the restriction of N neighborhood described above with reference to FIG. 3 may be employed so as to prevent the same image from being used for multiple blocks.

The replacement-image determination processing is executed as described above.

Referring back to FIG. 5, in step S65 subsequent to the processing in step S64, the image replacing unit 36 replaces the image of the block with the image selected in the processing in step S104. The image of each of all blocks is replaced with the image selected in the processing in step S104, as in the manner described, so that a mosaic image is created.

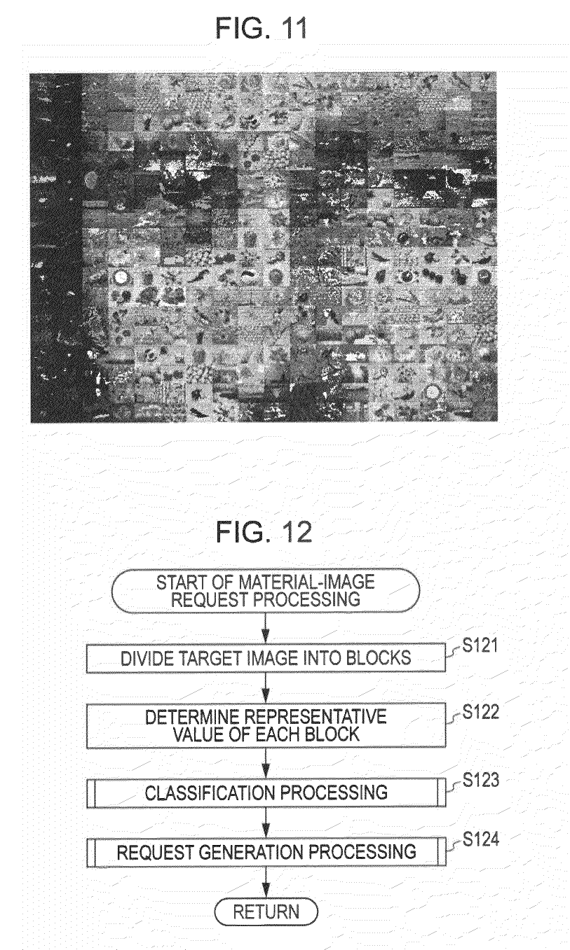

Consequently, for example, a photomosaic image as shown in FIG. 11 is created. FIG. 11 shows an example of a photomosaic image corresponding to the target image shown in FIG. 6.

That is, the target image shown in FIG. 6 is divided into blocks, as shown in FIG. 7, and is classified into classes, as shown in FIG. 9. The image of each block is then compared with the images in the class into which the image is classified and is replaced with the corresponding image in the image database 51. As a result, a photomosaic image as shown in FIG. 11 is created from the target image shown in FIG. 6.

The image creation processing is executed as described above.

The above-described image creation processing is executed based on the premise that images to be used for generating a photomosaic image are already stored in the image database 51. When images to be used for generating a photomosaic image are insufficient in the images in the image database 51, material-image request processing described below is executed prior to the image creation processing.

An example of material-image request processing performed by the photomosaic-image creating device 10 will now be described with reference to a flowchart shown in FIG. 12.

In step S121, the block dividing unit 31 in the photomosaic-image creator 30 divides a target image into blocks. In this case, the block dividing unit 31 divides a target image into, for example, rectangular blocks constituted by 320 pixels in a horizontal direction and 240 pixels in a vertical direction.

In step S122, the representative-value determining unit 32 determines a representative value of each of the blocks divided in the processing in step S121. Each representative value may be, for example, an average value of pixel values of the block or a pixel value at the center coordinate position of the block. Alternatively, each representative value may be an average value of pixel values at predetermined coordinate positions in the block.

In step S123, the target-image classifying unit 34 and the image-database classifying unit 37 execute classification processing. In this case, the class-center-value determining unit 33, the target-image classifying unit 34, and the image-database classifying unit 37 classify the image of each of the blocks and each of the images stored in the image database 51, on the basis of the block representative values determined in the processing in step S122.

Since the classification processing in step S123 is analogous to the classification processing in step S63 described above with reference to FIG. 5, a detailed description thereof is not given hereinbelow.

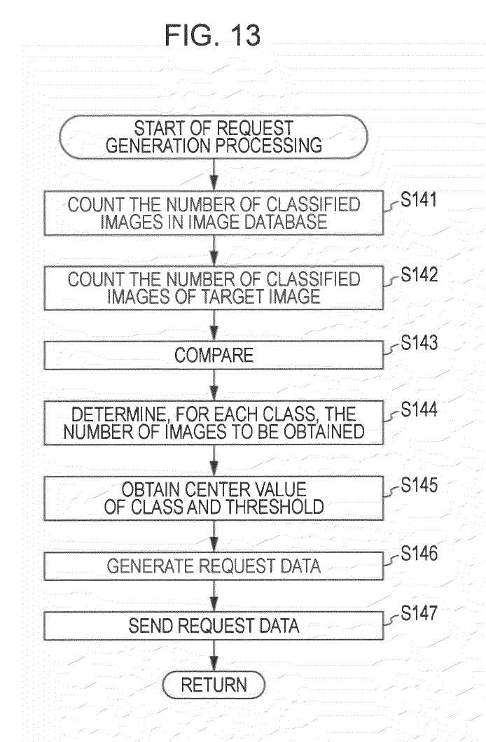

In step S124, the image request processor 70 executes request generation processing, which is described below with reference to FIG. 13. In the request generation processing, the above-described request data is generated and is transmitted to the image capture device 100.

A detailed example of the request generation processing in step S124 in FIG. 12 will now be described with reference to a flowchart shown in FIG. 13.

In step S141, the image-database counter 71 counts the number of images classified into each class, on the basis of the result of the classification (i.e., the processing in step S84 in FIG. 8) of the images stored in the image database 51, the classification being performed by the image-database classifying unit 37.

In step S142, the target-image counter 72 counts the number of blocks classified into each class, on the basis of the result of the classification (i.e., the processing in step S83 in FIG. 8) of the images of the blocks, the classification being performed by the target-image classifying unit 34.

In step S143, the comparing unit 73 compares the number of blocks counted in the processing in step S142 with the number of images counted in the processing in step S141. Thus, in the processing in step S143, the number of blocks of the target image which are classified into each class is compared with the number of images stored in the image database 51 and classified in the corresponding class.

In step S144, on the basis of the result of the comparison performed in step S143, the comparing unit 73 determines, for each class, the number of images to be obtained. That is, the comparing unit 73 determines a class not having sufficient images in the image database 51 and generates information indicating in which class and how many images in the image database 51 are insufficient. The information is supplied to the request generating unit 74.

In step S145, the request generating unit 74 obtains the each-class center value determined by the class-center-value determining unit 33 (i.e., the processing in step S82 in FIG. 8) and the threshold used for the classification (i.e., the processing in step S84) performed by the image-database classifying unit 37.

In step S146, the request generating unit 74 generates request data on the basis of the information obtained in the processing in step S144 and the center value and the threshold obtained in the processing in step S145. The request data generated in the processing in step S146 contains the information indicating in which class and how many images in the image database 51 are insufficient and the center value of the class not having sufficient images (and the threshold).

For example, images increased by a predetermine rate relative to the number of actually insufficient images may be transmitted using the request data. With this arrangement, it is possible to collect images that are more suitable for the blocks of the target image.

In step S147, the request data generated in step S146 is transmitted, as information to be used for obtaining an image or images in the class not having sufficient images, to the image capture device 100 through, for example, wireless communication.

The request generation processing is executed as described above.

With this arrangement, the information to be used for obtaining the image(s) in the class not having sufficient images in the image database 51, the images being used for creating the photomosaic image can be transmitted to the image capture device 100. Thus, the image capture device 100 can obtain the image(s) in the class not having sufficient images in the image database 51, the images being used for creating the photomosaic image.

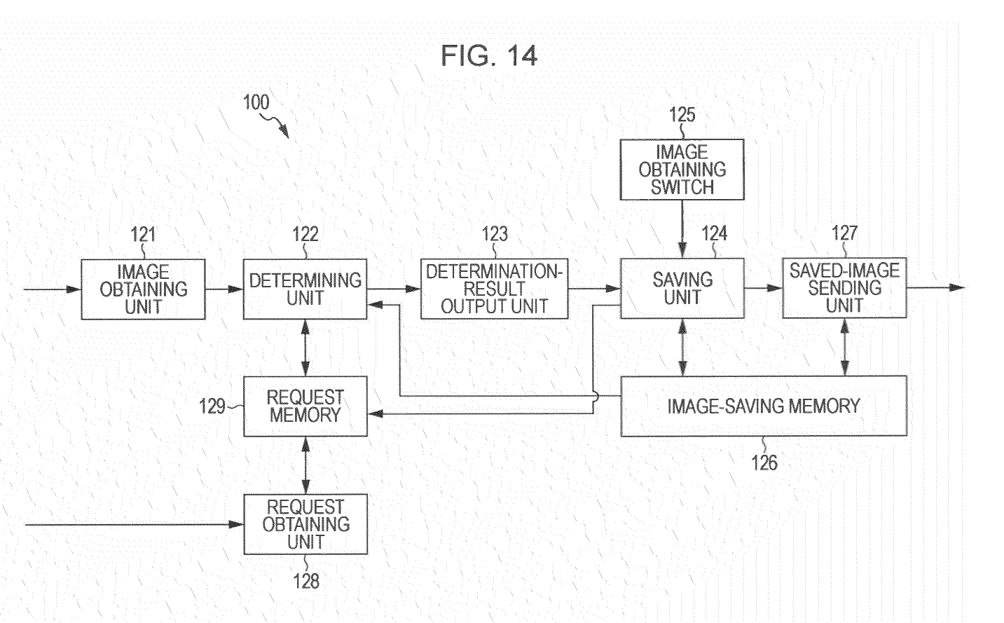

The image capture device 100 will be described next. FIG. 14 is a block diagram showing an example of a detailed configuration of the image capture device 100 shown in FIG. 1.

As shown in FIG. 14, the image capture device 100 includes an image obtaining unit 121, a determining unit 122, a determination-result output unit 123, a saving unit 124, an image obtaining switch 125, an image-saving memory 126, a saved-image sending unit 127, a request obtaining unit 128, and a request memory 129.

The request obtaining unit 128 is adapted to obtain the request data transmitted from the photomosaic-image creating device 10. The request obtaining unit 128 is configured as a communication interface for transmitting/receiving information to/from the photomosaic-image creating device 10 through, for example, wireless or wired communication. Alternatively, the request obtaining unit 128 may be configured as a drive to which a memory card or the like in which the request data is recorded is attached.

The request memory 129 is adapted to hold the request data obtained by the request obtaining unit 128.

The image obtaining unit 121 includes, for example, an image capture element using a CCD (charge-coupled device) and is adapted to generate data of an image corresponding to light focused via a lens (not shown).

On the basis of the contents of the request data held in the request memory 129, the determining unit 122 determines whether or not the image obtained by the image obtaining unit 121 is one requested by the photomosaic-image creating device 10.

The determining unit 122 extracts, for example, an image having a predetermined frame from data (e.g., moving-image data) supplied from the image obtaining unit 121 and determines a representative value of the extracted image. The determining unit 122 performs classification on the basis of, for example, the each-class center value and the threshold contained in the request data, as in the case of the image-database classifying unit 37. That is, the determining unit 122 determines a distance between the center value of each class and the representative value of the image obtained from the image obtaining unit 121, to thereby classify the image. The determining unit 122 further determines whether or not the image subjected to the classification corresponds to one of the images in the class not having sufficient images.

Although the description has been given an example in which only whether or not the image corresponds to one of the images in the class not having sufficient images is determined in the determination performed by the determining unit 122, another condition may also be determined.

For example, the determining unit 122 may further determine whether or not the image is similar to one of captured and saved images (i.e., images saved in the image-saving memory 126). That is, the determining unit 122 may determine whether or not the image is an image that corresponds to one of the images in the class not having sufficient images and that is not similar to any of the captured and saved images.

For example, attachment of similar images to adjacent blocks in a photomosaic image may provide a visual effect that is similar to a case in which the same image is used for multiple blocks. In order to prevent only similar images from being saved, for example, the arrangement may also be such that a similarity between each of the images in the image-saving memory 126 and an image obtained from the image obtaining unit 121 is determined and only an image having a similarity that is smaller than or equal to a threshold is determined as an image requested by the photomosaic-image creating device 10. For example, a value obtained by a block matching method or the like can be used as the similarity of the image.

Alternatively, the arrangement may also be made further considering, for example, motion blur, bokeh, and noise of the captured and saved images. For example, the arrangement may also be such that, when the amount of motion blur, bokeh, or noise of the captured and saved images is large, even an image whose similarity exceeds a threshold is determined as an image requested by the photomosaic-image creating device 10.

The determination-result output unit 123 presents a user with information indicating whether or not the image is one requested by the photomosaic-image creating device 10, on the basis of the result of the determination performed by the determining unit 122. For example, the determination-result output unit 123 presents the user with information indicating whether or not the image corresponds to one of the images in the class not having sufficient images. The presentation of the information indicating whether or not the image corresponds to one of the images in the class not having sufficient images may be realized by, for example, display on a liquid-crystal monitor or the like (not shown) of the image capture device 100 or may be realized by output of a preset sound from a speaker.

In this case, the color and/or shape of an image displayed on the liquid-crystal monitor may be varied or the pitch of the sound output from the speaker may be varied in accordance with the distance between the center value of each class and the representative value of the image obtained from the image obtaining unit 121. With this arrangement, the user can recognize how much a currently captured image is close to one requested by the photomosaic-image creating device 10.

Data of the image obtained from the image obtaining unit 121 is supplied to the saving unit 124 through the determining unit 122 and the determination-result output unit 123.

The saving unit 124 is adapted to save the data of the image at timing designated by the image obtaining switch 125. The image obtaining switch 125 is configured as, for example, as a shutter for the image capture device 100. When the image obtaining switch 125 is pressed, the data of an image (still image) is saved in the image-saving memory 126.

The user operates the image obtaining switch 125 on the basis of, for example, the above-described information presented by the determination-result output unit 123. The image data saved in the saving unit 124, as described above, may be stored in the image-saving memory 126 in association with, for example, the information indicating the result of the classification of the image.

When an image in the class not having sufficient images is saved, the contents of the request data stored in the request memory 129 may be updated on the basis of the information output from the saving unit 124. That is, when one image in the class not having sufficient images is saved, the number of insufficient images in the class may be decremented by 1.

The above-described information presented by the determination-result output unit 123 may be varied in accordance with the number of insufficient images. With this arrangement, the user can recognize how many more images are to be captured.

The saved-image sending unit 127 is adapted to send the image data, stored in the image-saving memory 126, to the photomosaic-image creating device 10. The sending of the image data may be performed through, for example, wired or wireless communication or may be performed via a memory card or the like.

The image data sent in such a manner is stored in, for example, the image database 51 and is used for the image creation processing described above with reference to FIG. 5.

With this configuration, the image capture device 100 can appropriately capture images that enable a photomosaic image to express texture of a target image and that are suitable to be attached to the blocks of the target image.

In general, for example, a picture obtained by photographing an object whose entire surface is red, blue, or the like is not suitable as an image to be used as a mosaic tile for creation of a photomosaic image. This is because the photomosaic image has an aesthetic feature in that, for example, the observer's impression varies greatly between when viewed at a distance and when observed at a short distance. It has typically been difficult for a general user to intentionally photograph images that are suitable as such mosaic tiles, thus making it difficult to create the image database or the like.

In contrast, according to the present invention, the image capture device 100 determines whether or not a currently captured image is one requested by the photomosaic-image creating device 10 and presents the result of the determination. Thus, according to the present invention, a general user can intentionally photograph images that are suitable as mosaic tiles.

Consequently, according to the present invention, it is possible to easily collect images to be used for creating a beautiful photomosaic.

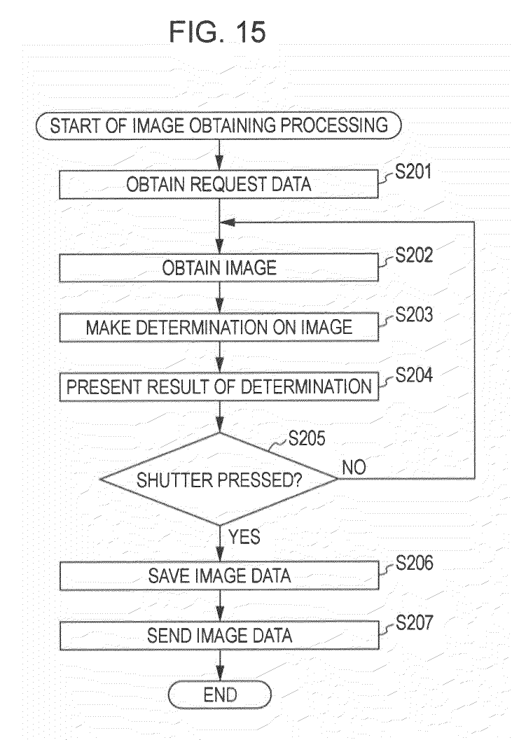

Image obtaining processing performed by the image capture device 100 will now be described with reference to a flowchart shown in FIG. 15.

In step S201, the request obtaining unit 128 obtains the request data transmitted from the photomosaic-image creating device 10. The request data obtained by the request obtaining unit 128 is held in the request memory 129.

In step S202, the image obtaining unit 121 obtains an image. In this case, for example, an image capture element using a CCD or the like generates data of an image corresponding to light focused via a lens.

In step S203, on the basis of the contents of the request data obtained in the processing in step S201, the determining unit 122 determines whether or not the image obtained in the processing in step S202 is one requested by the photomosaic-image creating device 10.

In this case, the determining unit 122 extracts, for example, an image having a predetermined frame from the data obtained in step S201 and determines a representative value of the extracted image. The determining unit 122 then performs classification on the basis of the each-class center value and the threshold contained in the request data. That is, the determining unit 122 determines a distance between the center value of each class and the representative value of the image obtained from the image obtaining unit 121, to thereby classify the image. The determining unit 122 further determines whether or not the image subjected to the classification corresponds to one of the images in the class not having sufficient images.

For example, the determining unit 122 may further determine whether or not the image is similar to one of the captured and saved images. That is, the determining unit 122 may also determine whether or not the image is an image that corresponds to one of the images in the class not having sufficient images and that is not similar to any of the captured and saved images.

Alternatively, the arrangement may also be made further considering, for example, motion blur, bokeh, and noise of the captured and saved images. For example, the arrangement may be such that, when the amount of motion blur, bokeh, or noise of the captured and saved images is large, even an image whose similarity exceeds a threshold is also determined as an image requested by the photomosaic-image creating device 10.

In step S204, the determination-result output unit 123 notifies the user about information indicating whether or not the image is one requested by the photomosaic-image creating device 10, on the basis of the result of the determination performed in the processing in step S203. For example, the determination-result output unit 123 presents information indicating whether or not the image corresponds to one of the images in the class not having sufficient images. The presentation of the information indicating whether or not the image corresponds to one of the images in the class not having sufficient images may be realized by, for example, display on a liquid-crystal monitor or the like (not shown) of the image capture device 100 or may be realized by output of a preset sound from a speaker.

In this case, the color and/or shape of an image displayed on the liquid-crystal monitor may be varied or the pitch of the sound output from the speaker may be varied in accordance with the distance between the center value of each class and the representative value of the image obtained from the image obtaining unit 121. With this arrangement, the user can recognize how much a currently captured image is close to one requested by the photomosaic-image creating device 10.

In step S205, the saving unit 124 determines whether or not the image obtaining switch 125 (e.g., a shutter) is pressed. When it is determined that the image obtaining switch 125 is not pressed, the process returns to step S202 and the processing in step S202 and the subsequent steps is executed again. When it is determined in step S205 that the image obtaining switch 125 (e.g., a shutter) is pressed, the process proceeds to step S206.

In step S206, the saving unit 124 saves data of the captured image. The user operates the image obtaining switch 125 on the basis of, for example, the information presented in the processing in step S204. When the image obtaining switch 125 is pressed, the data of the image (still image) is saved in the saving unit 124. The image data saved in the saving unit 124 may be stored in the image-saving memory 126 in association with, for example, the information indicating the result of the classification of the image.

When an image in the class not having sufficient images is saved, the contents of the request data stored in the request memory 129 may be updated on the basis of the information output from the saving unit 124. That is, when one image in the class not having sufficient images is saved, the number of insufficient images in the class may be decremented by 1.

In step S207, the saved-image sending unit 127 is adapted to send the image data, stored in the image-saving memory 126, to the photomosaic-image creating device 10. In this case, the image data is sent through, for example, wired or wireless communication. Alternatively, the image data may be sent via a memory card or the like.

The processing in step S207 may be performed only when the user gives an instruction for sending the image data.

The image data sent in the processing in step S207 is stored in, for example, the image database 51 and is used for the image creation processing described above with reference to FIG. 5.

The image obtaining processing is executed as described above. With this arrangement, a general user can intentionally photograph images that are suitable as mosaic tiles. Consequently, it is possible to easily collect images to be used for creating a beautiful photomosaic.

In the example described above with reference to FIGS. 14 and 15, the user operates the image obtaining switch 125 on the basis of the information presented by the determination-result output unit 123 and the corresponding image is saved at the time of the operation.

With this arrangement, for example, the user can capture an image while searching for an appropriate angle in accordance with a change in the pitch or the like of a sound output from the speaker and thus can enjoy the process of searching for the appropriate angle as if it were a game.

With this arrangement, for example, the user can also learn features of images that are suitable for use as tiles of a photomosaic image, each time he or she takes a picture with the image capture device 100 (e.g., a camera). In general, for example, a picture obtained by photographing an object whose entire surface is red, blue, or the like is not suitable as an image to be used as a mosaic tile for creation of a photomosaic image. This is because the photomosaic image has an aesthetic feature in that, for example, the observer's impression varies greatly between when viewed at a distance and when observed at a short distance. Thus, for example, an image that does not appear at a glance as an image in red, blue, or the like and that appears as an image in red, blue, or the like when viewed at a distance, can be said to be an image that is suitable as an image for use as a tile of a photomosaic image.

In the example described above with reference to FIGS. 14 and 15, the user can be provided with such a color sensation.

The image capture device 100 may also be configured so that it can automatically save a currently captured image when it is an image requested by the photomosaic-image creating device 10.

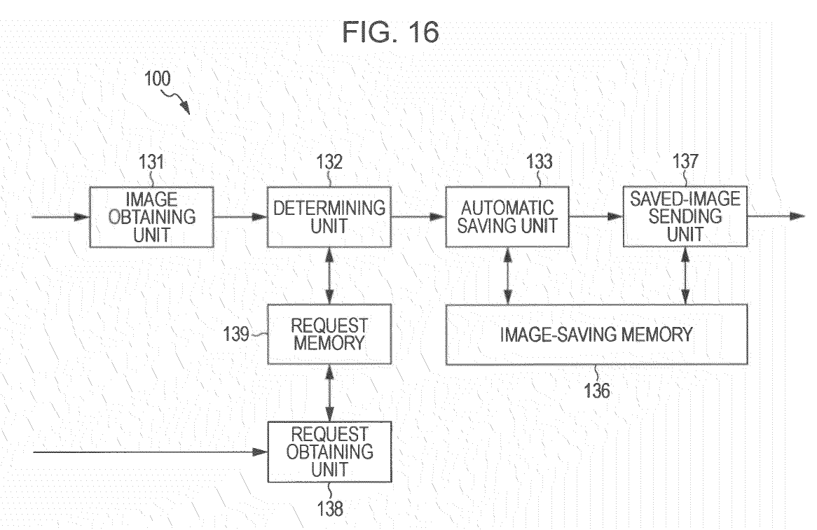

FIG. 16 is a block diagram showing another example of the detailed configuration of the image capture device 100 shown in FIG. 1.

Since an image obtaining unit 131 and a determining unit 132 shown in FIG. 16 are similar to the image obtaining unit 121 and the determining unit 122 shown in FIG. 14, respectively, detailed descriptions thereof are given hereinbelow. Since an image-saving memory 136, a saved-image sending unit 137, a request obtaining unit 138, and a request memory 139 shown in FIG. 16 are similar to the image-saving memory 126, the saved-image sending unit 127, the request obtaining unit 128, and the request memory 129 shown in FIG. 14, respectively, detailed descriptions thereof are not given hereinbelow.

In the example of FIG. 16, the determination-result output unit 123, the saving unit 124, and the image obtaining switch 125 are not provided unlike the case in FIG. 14. In the example of FIG. 16, an automatic saving unit 133 is provided unlike the case in FIG. 14.

When the result of the determination performed by the determining unit 132 indicates that the image is one requested by the photomosaic-image creating device 10, the automatic saving unit 133 is adapted to automatically save the image.

That is, in the example of FIG. 16, the image capture device 100 automatically saves a currently captured image when it is an image requested by the photomosaic-image creating device 10. With this arrangement, for example, when the user merely directs the lens of the image capture device 100 to various subjects, an image requested by the photomosaic-image creating device 10 can be automatically obtained.

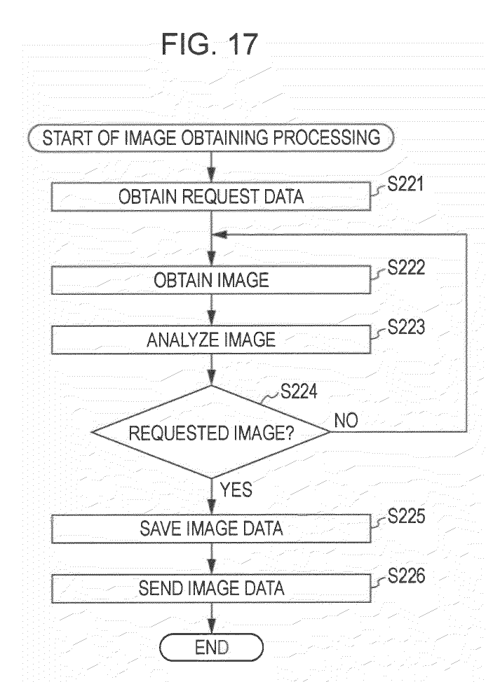

Image obtaining processing performed when the image capture device 100 shown in FIG. 1 is configured as in FIG. 16 will now be described with reference to a flowchart shown in FIG. 17.

In step S221, the request obtaining unit 138 obtains the request data transmitted from the photomosaic-image creating device 10. The request data obtained by the request obtaining unit 138 is held in the request memory 139.

In step S222, the image obtaining unit 131 obtains an image. In this case, for example, an image capture element using a CCD or the like generates data of an image corresponding to light focused via a lens.

In step S223, on the basis of the contents of the request data obtained in the processing in step S221, the determining unit 132 analyzes the image obtained in the processing in step S222. That is, the determining unit 132 performs analysis for determining whether or not the image is one requested by the photomosaic-image creating device 10.

In this case, the determining unit 132 extracts, for example, an image having a predetermined frame from the data obtained in step S221 and determines a representative value of the extracted image. The determining unit 132 then performs classification on the basis of the each-class center value and the threshold contained in the request data. That is, the determining unit 132 determines a distance between the center value of each class and the representative value of the image obtained from the image obtaining unit 131, to thereby classify the image. The determining unit 132 further performs analysis as to whether or not the image subjected to the classification corresponds to one of the images in the class not having sufficient images.

For example, the determining unit 132 may further perform analysis as to whether or not the image is similar to one of captured and saved images. That is, the determining unit 132 may perform analysis as to whether or not the image is an image that corresponds to one of the images in the class not having sufficient images and that is not similar to any of the captured and saved images.

Alternatively, the arrangement may also be made further considering, for example, motion blur, bokeh, and noise of the captured and saved images.

In step S224, on the basis of the result of the analysis performed in the processing in step S223, the automatic saving unit 133 determines whether or not the image obtained in step S222 is one requested by the photomosaic-image creating device 10. When it is determined in step S224 that the image is not one requested by the photomosaic-image creating device 10, the process returns to step S222 and the processing in step S222 and the subsequent steps is executed again.

When it is determined in step S224 that the image is one requested by the photomosaic-image creating device 10, the process proceeds to step S225.

In step S225, the automatic saving unit 133 saves data of the image. The image data saved in the automatic saving unit 133 may be stored in the image-saving memory 136 in association with, for example, the information indicating the result of the classification of the image.

When an image in the class not having sufficient images is saved, the contents of the request data stored in the request memory 139 may be updated on the basis of information output from the automatic saving unit 133. That is, when one image in the class not having sufficient images is saved, the number of insufficient images in the class may be decremented by 1.

In step S226, the saved-image sending unit 137 is adapted to send the image data, stored in the image-saving memory 136, to the photomosaic-image creating device 10. In this case, the image data is sent through, for example, wired or wireless communication. Alternatively, the image data may be sent via a memory card or the like.

The processing in step S226 may be performed only when the user gives an instruction for sending the image data.

The image data sent in the processing in step S226 is stored in, for example, the image database 51 and is used for the image creation processing described above with reference to FIG. 5.

The image obtaining processing may be executed as described above. With this arrangement, for example, it is possible to more easily collect images to be used for creating a beautiful photomosaic, compared to the case of the example shown in FIG. 15.

Although the image capture device 100 has been described above as being implemented as a digital camera or the like, it goes without saying that it may be implemented as, for example, an image-capture-unit-equipped electronic device, such as a mobile phone.

The images stored in the image database 51 and the target image may be not only pictures but also any images, such CGs (computer graphics) and images resulting from capture of paintings and so on with a scanner.

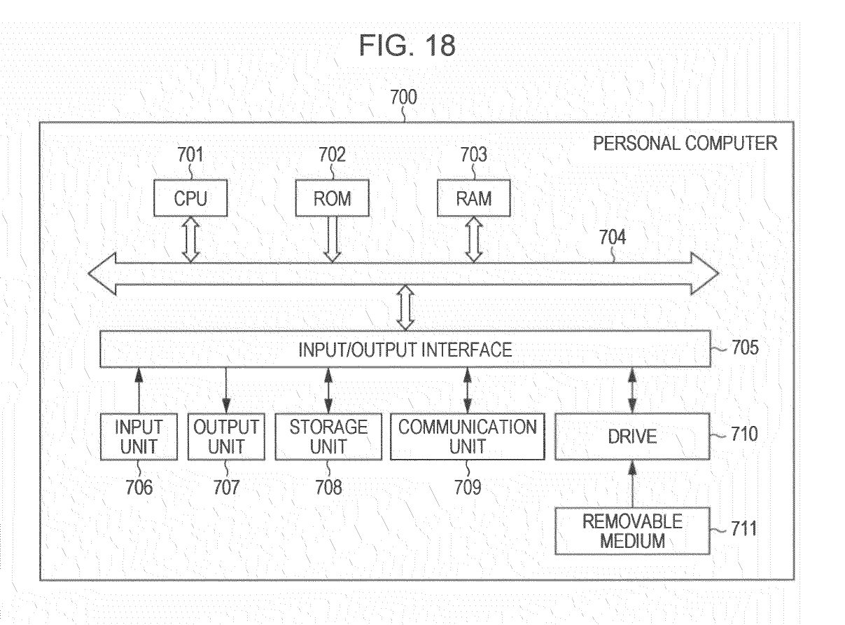

The above-described series of processing can be executed by hardware or software. When the above-described series of processing is executed by software, a program included in the software is installed from a network or a recording medium onto a computer incorporated into dedicated hardware. The program may also be installed from a network or a recording medium onto a computer that is capable of executing various functions through installation of various programs, for example, onto a general-purpose personal computer 700, as shown in FIG. 18.

In FIG. 18, a CPU (central processing unit) 701 executes various types of processing in accordance with a program stored in a ROM (read only memory) 702 or a program loaded from a storage unit 708 into a RAM (random access memory) 703. The RAM 703 also stores, for example, data that the CPU 701 uses to execute various types of processing, as appropriate.

The CPU 701, the ROM 702, and the RAM 703 are interconnected through a bus 704. The bus 704 is also connected to an input/output interface 705.

An input unit 706, an output unit 707, the storage unit 708, and a communication unit 709 are connected to the input/output interface 705. The input unit 706 includes a keyboard, a mouse, and so on. The output unit 707 includes a display, such as an LCD (liquid crystal display), and a speaker. The storage unit 708 includes a hard disk or the like. The communication unit 709 includes, for example, a network interface card, such as a modem or a LAN (local area network) card. The communication unit 709 performs processing for communication over a network including the Internet.

A drive 710 is also connected to the input/output interface 705, as appropriate. A removable medium 711, such as magnetic disk, an optical disk, a magneto-optical disk, or a semiconductor memory, is loaded into the drive 710, as appropriate. A computer program read from the removable medium 711 is installed on the storage unit 708, as appropriate.

When the above-described series of processing is executed by software, a program included in the software is installed through a network, such as the Internet, or via a recording medium, such as the removable medium 711.

For example, the recording medium may be not only the removable medium 711 (on which the program is recorded) that is distributed to a user to supply the program, independently from the main unit of an apparatus as shown in FIG. 18, but also the ROM 702 (in which the program is recorded), the hard disk included in the storage unit 708, or the like distributed to a user in a state in which it is preinstalled in the main unit of the apparatus. Examples of the removable medium 711 includes a magnetic disk (including a floppy® disk), an optical disk (including a CD-ROM [Compact Disc-Read Only Memory] and a DVD [Digital Versatile Disc]), a magneto-optical disc (including an MD® [Mini Disc]), and a semiconductor memory.

The series of processing described hereinabove not only include processing that is time-sequentially performed according to the described sequence, but also include processing that is concurrently or individually executed without being necessarily time-sequentially processed.

The present application contains subject matter related to that disclosed in Japanese Priority Patent Application JP 2009-204424 filed in the Japan Patent Office on Sep. 4, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image capture device comprising:
request-data obtaining means for obtaining request data output from an image processing device;
determining means for determining whether or not an input image is an image requested by the image processing device, on a basis of information contained in the request data;
presenting means for presenting a user with a result of the determination; and
saving means for saving the input image at timing designated by the user.

2. The image capture device according to claim 1, wherein the request data contains information of preset classes and a center value of each class; and
the determining means classifies the input image into one of the classes by determining a distance between a representative value of the input image and the center value, and when the request data contains information indicating that the number of images in the class of the input image is insufficient, the determining means determines that the input image is the image requested by the image processing device.

3. The image capture device according to claim 2, wherein the request data further contains a threshold for classifying the input image into one of the classes; and
when the distance between the representative value of the input image and the center value is smaller than or equal to the threshold, the determining means classifies the input image into the class corresponding to the center value.

4. The image capture device according to claim 2, wherein the determining means further determines a similarity between an image already saved by the saving means and the input image; and
when the request data contains the information indicating that the number of images in the class of the input image is insufficient and the similarity is smaller than or equal to a threshold, the determining means determines that the input image is the image requested by the image processing device.

5. The image capture device according to claim 2, further comprising automatic saving means for saving, regardless of designation by the user, the input image determined by the determining means to be the image requested by the image processing device.

6. The image capture device according to claim 1, further comprising sending means for sending the saved input image to the image processing device as a material image to be used for creating a photomosaic image.

7. An image capture method comprising the steps of:
causing request-data obtaining means to obtain request data output from an image processing device;
causing determining means to determine whether or not an input image is an image requested by the image processing device, on a basis of information contained in the request data;
causing presenting means to present a user with a result of the determination; and
causing saving means to save the input image at timing designated by the user.

8. A program that causes a computer to function as an image capture device comprising:
request-data obtaining means for obtaining request data output from an image processing device;
determining means for determining whether or not an input image is an image requested by the image processing device, on a basis of information contained in the request data;
presenting means for presenting a user with a result of the determination; and
saving means for saving the input image at timing designated by the user.

9. An image processing device comprising:
dividing means for dividing an input image into blocks;
block-image classifying means for classifying the divided blocks into preset classes, on a basis of representative values of the images of the blocks;
material-image classifying means for classifying material images, stored as images to be attached to the blocks, into the classes;
comparing means for comparing the number of blocks classified into each of the classes with the number of material images classified into each of the classes;
insufficient-image identifying means for identifying a class in which the number of material images is insufficient and the number of insufficient material images, on a basis of a result of the comparison;
request-data generating means for generating request data containing the identified class, the number of insufficient material images, and a center value of the class; and
sending means for sending the generated request data to an image capture device.

10. The image processing device according to claim 9, further comprising:
material-image determining means for determining the material image to be attached to each block, by comparing each of the material images, classified into the same class as the class of the block, with the image of the block in accordance with a predetermined criteria; and
photomosaic-image creating means for creating a photomosaic image corresponding to the input image by attaching the determined material image to the block.

11. The image processing device according to claim 10, wherein the material-image determining means performs the comparison by determining suitability of the material image to be attached to the block on a basis of a distance between a pixel value of the material image, classified into the same class as the class of the block, with a pixel value of a corresponding pixel in the image of the block.

12. The image processing device according to claim 9, wherein the block-image classifying means comprises center-value determining means for determining the center values of the classes on a basis of the representative values of the images of the blocks, and classifies the images of the blocks into the classes on a basis of a distance between the center value and the representative value of the image of the block; and
the material-image classifying means classifies the material images into the classes on a basis of the distance between the center value and the representative value of the material image and a threshold for the distance.

13. An image processing method comprising the steps of:
causing dividing means to divide an input image into blocks;
causing block-image classifying means to classify the divided blocks into preset classes, on a basis of representative values of the images of the blocks;
causing material-image classifying means to classify material images, stored as images to be attached to the blocks, into the classes;
causing comparing means to compare the number of blocks classified into each of the classes with the number of material images classified into each of the classes;
causing insufficient-image identifying means to identify a class in which the number of material images is insufficient and the number of insufficient material images, on a basis of a result of the comparison;
causing request-data generating means to generate request data containing the identified class, the number of insufficient material images, and a center value of the class; and
causing sending means to send the generated request data to an image capture device.

14. A program causing a computer to function as an image processing device comprising:
dividing means for dividing an input image into blocks;
block-image classifying means for classifying the divided blocks into preset classes, on a basis of representative values of the images of the blocks;
material-image classifying means for classifying material images, stored as images to be attached to the blocks, into the classes;
comparing means for comparing the number of blocks classified into each of the classes with the number of material images classified into each of the classes;
insufficient-image identifying means for identifying a class in which the number of material images is insufficient and the number of insufficient material images, on a basis of a result of the comparison;
request-data generating means for generating request data containing the identified class, the number of insufficient material images, and a center value of the class; and
sending means for sending the generated request data to an image capture device.

15. An image capture device comprising:
a request-data obtaining unit configured to obtain request data output from an image processing device;
a determining unit configured to determine whether or not an input image is an image requested by the image processing device, on a basis of information contained in the request data;
a presenting unit configured to present a user with a result of the determination; and
a saving configured to save the input image at timing designated by the user.

16. An image processing device comprising:
a dividing unit configured to divide an input image into blocks;
a block-image classifying unit configured to classify the divided blocks into preset classes, on a basis of representative values of the images of the blocks;
a material-image classifying unit configured to classify material images, stored as images to be attached to the blocks, into the classes;
a comparing unit configured to compare the number of blocks classified into each of the classes with the number of material images classified into each of the classes;
an insufficient-image identifying unit configured to identify a class in which the number of material images is insufficient and the number of insufficient material images, on a basis of a result of the comparison;
a request-data generating unit configured to generate request data containing the identified class, the number of insufficient material images, and a center value of the class; and
a sending unit configured to send the generated request data to an image capture device.
